(19) United States
(12) Patent Application Publication
(10) Pub. No.: US 2009/0274993 A1
(43) Pub. Date: Nov. 5, 2009

(54) PROCESS FOR PRODUCTION OF A DENTAL COMPONENT AND ARRANGEMENT OF SUCH COMPONENT

(75) Inventors: Lennart Bergstrom, Enskede (SE); Erik Laarz, Stockholm (SE); Erik Adolfsson, Goteborg (SE); Ng Sing Boon, Taby (SE); Matts Andersson, Lerum (SE)

Correspondence Address: KNOBBE MARTENS OLSON & BEAR LLP, 2040 MAIN STREET, FOURTEENTH FLOOR, IRVINE, CA, 92614, US

(73) Assignee: NOBEL BIOCARE SERVICES AG, Zurich-Flughfen (CH)

(21) Appl. No.: 12/159,475

(22) PCT Filed: Dec. 22, 2006
(86) PCT No.: PCT/SE06/01488

§ 371 Date: Oct. 14, 2008

(30) Foreign Application Priority Data
Dec. 30, 2005 (SE) 0502936-8

(51) Int. Cl. A61C 13/00

(52) U.S. Cl. 433/201.1; 264/16; 264/17

(57) ABSTRACT

A manufacturing method and dental component are provided in which first and second cast parts are used with a casting material, such as a gel slurry, to form the dental component. The first cast part can be positioned in a space of the second cast part and a gel slurry can be applied intermediate the first and second cast parts. The gel slurry can then be solidified to form a solidified gel slurry. The first cast part can then be removed together with the solidified gel slurry from the second cast part. The solidified gel slurry can then be machined to form an exterior shape corresponding to a desired exterior shape of the dental component. Finally, the solidified gel slurry can be sintered.

### PRIORITY INFORMATION

This application is a U.S. National Phase of International Application No. PCT/SE2006/001488, filed Dec. 22, 2006, which claims priority to Swedish Patent Application No. SE 0502936-8, filed Dec. 30, 2005, each of which is hereby incorporated by reference in its entirety.

### BACKGROUND

1. Field of the Invention

The present invention concerns a process for producing a dental component. The invention also concerns an arrangement of such a dental component.

2. Description of the Related Art

Tests have been carried out for production of dental components, such as crowns, bridges, sleeves, abutments, etc., by casting processes using slurries. In this respect, use of slurries of amide-based MAM (methacrylamide) agent in combination with MBAM (methylene-bis-acrylamide) and initiators in the form of TEMED (tetramethyl ethylene diamine) and APS (ammonium persulphate) has been proposed.

Research has shown that components produced in such ways do not have sufficient technical material strength and fail to meet other dental-related requirements. The results of this research have caused a switch from production using slurries to the use of a pressing process (of green body). However, implementation of the pressing process has the disadvantage that it is difficult to avoid gradients and tensions are often built into the components that are made using such a process. A relevant example of production of ceramic components using a pressing process is shown in WO 2005/046502, which has the same applicant as the present application.

### SUMMARY OF THE INVENTION

In light of the above-mentioned problems, many have considered it necessary to find new approaches to the technical development of ceramic components that overcome and avoid the above-stated problems and other disadvantages. To the contrary, embodiments of the present invention go against this opinion and make use of slurry mixtures in a more effective manner, as described herein. Embodiments disclosed herein use slurry mixtures in the casting process as they are the most effective mixture for creating ceramic products that comply with the strength of material requirements of dental components. Further, embodiments disclosed herein provide for mixtures that have no inbuilt stresses and gradients which counteract the beneficial result of the dental installation, e.g., by the components changing shape during the production and installation in the jaw bone. In addition, embodiments disclosed herein make it possible to produce the components with great accuracy, e.g., within 0.01-0.02 mm. Finally, in accordance with some of the embodiments disclosed herein, is the recognition that it is important that the slurry has prominent low or no toxicity at all. Embodiments of the present invention are intended to solve the stated and other problems.

Gel casting of zirconium dioxide powder with various monomers is already known; see for example U.S. Pat. No. 5,145,908, U.S. Pat. No. 4,894,194, U.S. Pat. No. 6,066,279, and U.S. Pat. No. 6,228,299. In the last two mentioned publications, HEMA and PEGDMA are specified as monomers. Embodiments of the present invention provide improvements on this type of gel casting process.

According to an embodiment of the invention, a process is provided that comprises providing a first cast part with an outer shape corresponding to an inner shape of a dental component and applying the first cast part in a space of a second cast part. The volume of the space can exceed the volume of the first cast part. A gel slurry can be applied in the space remaining between the first and the second cast parts and the gel slurry can then be solidified. The first cast part can be removed, together with the solidified slurry, from the second cast part and the solidified gel slurry can then be processed to provide the dental component and an outer shape thereof Finally, the dental component can be formed from the processed solidified gel slurry is sintered.

In an embodiment of the method for making a dental component, a first cast part is provided with a first volume by milling. The first cast part can be applied together with casting material in the second cast part to provide a casting function with the first volume. In other words, the casting material can be applied to the first cast part and then both can be inserted into the second cast part in order to create a cast. As an aside, the casting material can comprise a gel slurry. Further, CAD/CAM tools can be used to produce the cast parts and/or the cast tools.

Returning to the description of the embodiment of the method, the first cast part can be removed from the casting material which remains in the second cast part. The casting material, which can comprise a shape of a recess corresponding to the first volume, can then be dried to provide a reduced second or interior volume. The outer shape of the first cast part can be processed to another outer shape corresponding to the second or interior volume or inner shape of the dried casting material. Then, the first cast part can be repositioned in recess of the dried casting material. Further developments of the inventive concept are evident from the following description of the process.

According to another embodiment, the dental component can comprise a gel slurry in which the inner and outer surfaces of the dental component are formed. Forming can be carried out by the above-mentioned CAD/CAM tools. The gel material or gel slurry can comprise zirconia, monomers, water, and dispersant. The casting material, gel material and/or gel slurry can comprise acrylate amide-based systems designated as HEMA-PEG 400 DMA (in which HEMA comprises 2-hydroxyethylmethacrylate; PEG=polyethylene glycol; DMA=dimethacrylate). Further developments of the inventive concept are also evident from the following additional description of the arrangement.

The initially stated and other problems are solved by embodiments of the invention. CAD/CAM tools in accordance with the automatic production system PROCERA® can be used to produce cast parts. Acrylate-based gel casting systems can be used to replace earlier amide-based systems. The kinetic reactions in the gel casting systems can, in accordance with embodiments of the invention, also be determined.

In addition, techniques have been developed for studying deformations during drying. The mechanical properties of the cast material show strength values which are equivalent to those of ceramic dental components manufactured by other methods.

Further, embodiments of the invention make possible new manufacturing processes for individual production of, e.g., crowns and bridges. The production becomes more cost effective. For example, it has been shown that production of ceramic dental components in accordance with the invention can be carried out with 40% cost reduction compared with other current production methods and apparatus.

Embodiments of the invention also propose a new gel casting method based on acrylate instead of amide. As a result, embodiments of the invention can acheive increased homogeneity and reduced deformation during the pressing function. Substantial versatility with respect to shape and size, as well as individual components or large series of components, can be provided. Requirements for the monomer used are in accordance with the above, e.g., reduced toxicity. The monomer can be water soluble and capable of being subjected to thermically induced polymerization. Further, the monomer can provide sufficient strength and does not cause adverse effects during ceramic sludging. The temperature threshold for the gel slurry can also be high; e.g., over 70° C.

### BRIEF DESCRIPTION OF THE DRAWINGS

The above-mentioned and other features of the inventions disclosed herein are described below with reference to the drawings of the preferred embodiments. The illustrated embodiments are intended to illustrate, but not to limit the inventions. The drawings contain the following figures:

FIG. 1 is a block diagram of an embodiment of a process in association with an automatic production system in accordance with an embodiment of the present inventions.

FIG. 2 is a perspective view illustrating in diagonal perspective, various embodiments of dental components.

FIG. 3 is a perspective view illustrating in diagonal perspective, further embodiments of dental components.

FIGS. 4-5 are perspective views illustrating in diagonal perspective, embodiments of dental prosthetics compatible with the components illustrated in FIGS. 2 and 3.

FIG. 6 is a block diagram of a test procedure for determining shape changes during a drying process according to an embodiment.

FIG. 7 is a chart of steps of an embodiment of a process for producing a dental component.

### DETAILED DESCRIPTION OF THE PREFERRED EMBODIMENTS

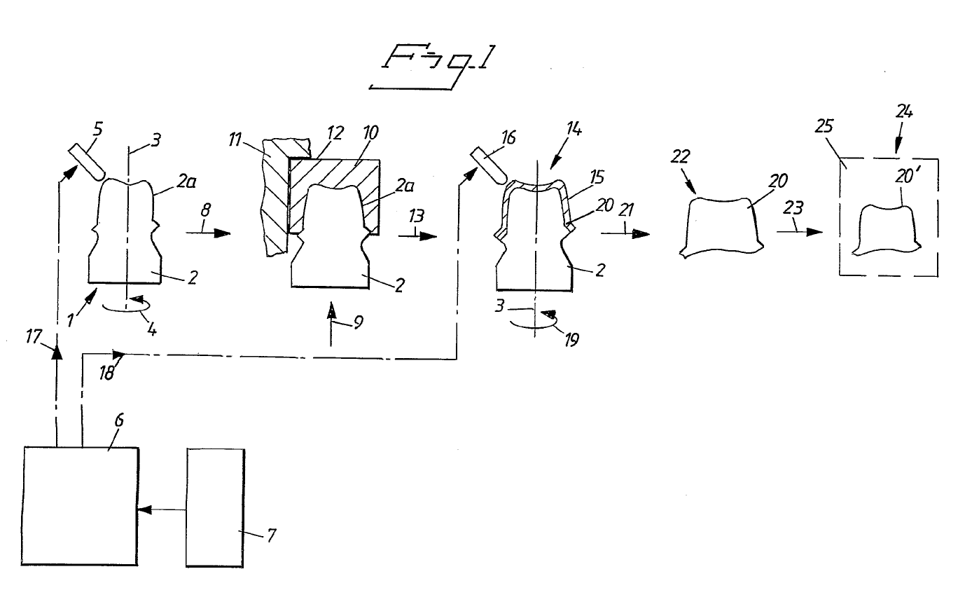

FIG. 1 illustrates various steps in crown production according to the fully automated system PROCERA® and embodiments of the invention. A symbolically represented cast station is designated by 1. A first cast part comprises a cast die designated by 2. The first case part or cast die 2 can have an upper surface or volume 2a. The cast die 2 can be rotated around its longitudinal axis 3 in a rotational direction 4. The upper surface 2a of the cast die 2 can be processed or machined or milled out using a symbolically represented milling tool 5. The milling tool 5 can be controlled by a CAD/CAM (Computer Aided design/Computer Aided Manufacturing) function in a production system and can include control devices 6 for this purpose. The control devices 6 can be part of a production chain and, in their turn, can be controlled in a known manner by further equipment 7 in the system. When the shape of the surface 2a has been formed, the cast die 2 can be transferred in the direction of arrow 8 to a cast station 9. Cast material 10, with a composition in accordance with the description below, can then be applied to the cast die 2 in the cast station 9 in a known manner.

In some embodiments, the cast material 10 can be a gel slurry.

As shown in FIG. 1, the application of the cast material 10 to the cast die 2 is provided by the cast die 2 being inserted into a second cast part 11. For example, the second cast part 11 can have a space 12 into which the cast die 2 can be received. The volume of the space 12 can exceed the volume of the part in question of the die 2. The part in question may be the part of the cast die 2 used to form the inner surface of the dental component. Hence, the volume formed by the outer surface 2a of the cast die 2 may form the volume of said part on question.

When the cast die 2 is inserted into the space 12, the cast material can applied in accordance with the an embodiment of the present invention. This cast material 10 can then be solidified. The cast die 2, with the thus solidified cast material 10, can then be removed from the second cast part 11 and its space 12. The cast die 2 with the applied, solidified cast material can be transferred in the direction of arrow 13 to a station 14.

In station 14, the solidified cast material is processed to provide the dental component and form an outer shape or outer surface 15 of the dental component. In station 14, the cast die 2 with the applied, solidified cast material can be rotationally arranged around the longitudinal axis 3 in a manner similar to the manner in which the upper surface 2a is produced. Thus, the outer shape or outer surface 15 of the dental component can be produced using a milling tool 16. The milling tool 16 can comprise milling tool 5 or other milling tools. In addition, milling tool 16 can be controlled by unit 6 in the automated production system.

The control signals for milling tool 5 and 16 are designated in FIG. 1 by 17 and 18, respectively. The milling with milling tool 16 can be provided by rotating the cast die 2 with the solidified cast material around the longitudinal axis 3 in a rotational direction 19.

When the outer shape of the dental component has been milled, the milled dental component 20 can be removed and transferred in the direction of arrow 21 to a station 22 and further in the direction of arrow 23 to a station 24 with an oven 25. In station 24, the dental component 20 is sintered so that it can adopt its final shape 20′. The sintering function can be performed using known sintering methods and devices.

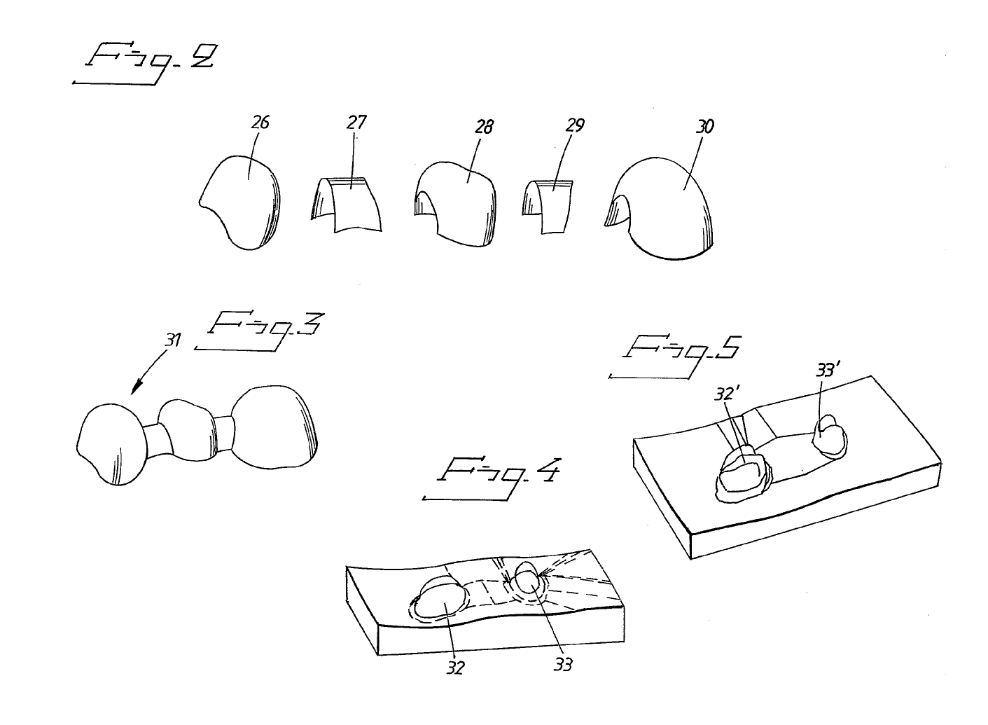

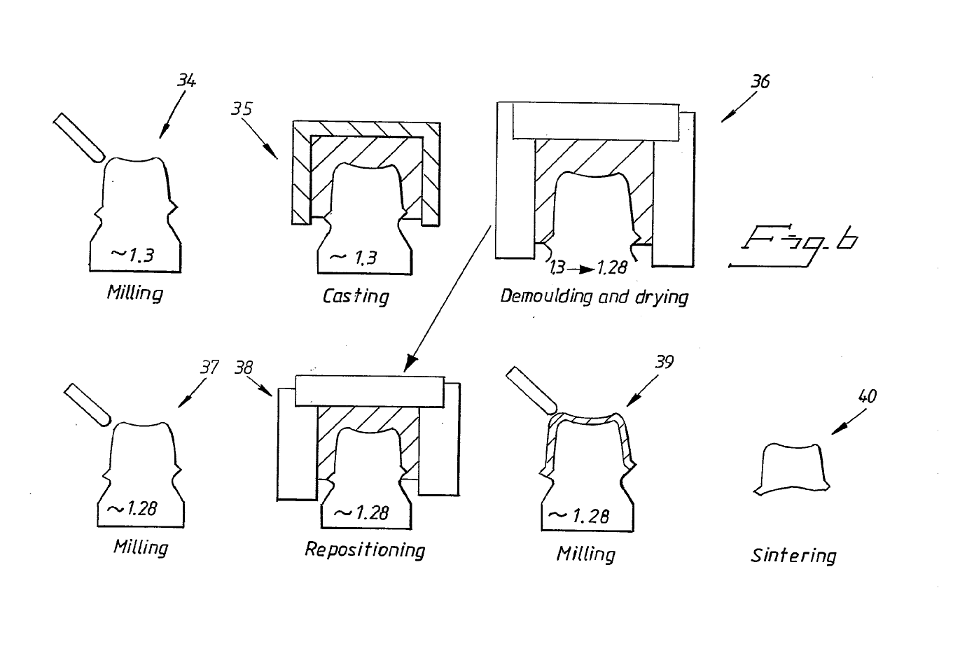

In accordance with FIGS. 2-5, dental components of various designs can be produced. FIG. 2 shows various constituent components in a bridge construction. The components can each be produced separately and thereafter assembled in a known manner. The components shown in FIG. 2 can be assembled to form a bridge assembly 31, as shown in FIG. 3. Elements 32, 33, 32′, and 33′ of FIGS. 4 and 5 show dental preparation configurations on which the dental component 31 can be applied.

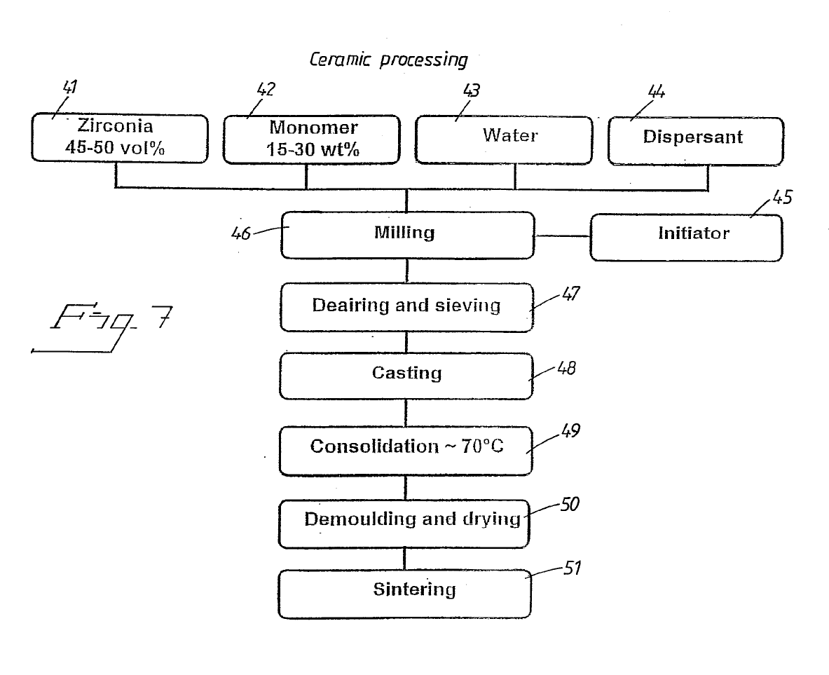

FIG. 6 illustrates an embodiment of a method in which the effects of drying of the dental component are demonstrated. In station 34, the outer volume or outer shape of a cast die is produced by milling in an equivalent manner to that mentioned above. In such an embodiment, the surface of the cast die is provided with a first diameter or corresponding measurement specified to 1.3.

In station 35, the cast die has, as above, been applied in the space in a second cast part, which is external to the cast die 2, and cast material has been applied in the space between the cast parts. When the cast material has solidified, the cast die is removed from the second cast part in which the solidified cast material is allowed to remain.

In station 36, the solidified cast material remaining in the second cast part is dried. As a result, the surface or volume of the solidified cast in question, or corresponding measurement, shrinks thereby to 1.28.

In station 37, the outer surface of the cast die previously removed from the solidified cast is milled until it has a value corresponding to the shrunken value for the cast material in the station 36; i.e., 1.28. As mentioned above, this cast material can be a gel slurry. Also, the shape of the cast die should correspond to the internal shape of the recess of dried cast material.

Then, in station 38 the cast die can be repositioned in a recess existing in the solidified cast material. In station 39, the solidified cast material is subsequently processed in accordance with the above in order to create a dental component and form the outer shape thereof.

In station 40 the dental component can be sintered in a manner as mentioned above. The dental component can thus be sintered such that it assumes its final size while retaining the same shape as before sintering.

In accordance with embodiments of the present invention, monomer HEMA and “crosslinker” PEG 400-DMA can be used. AZAP (azo-bis-aminidopropane dihydrochloric acid) can be used as initiator. Zirconia, water, and dispersant can also be used in embodiments of the component and process.

FIG. 7 shows an example of a process in accordance with embodiments of the invention. Zirconia 41 can comprise approximately 45-50% of the volume of the casting material. Monomer 42 can make up approximately 50-30% of the weight of the material. Also, water 43 and dispersant 44 can also be added. The initiator is indicated by 45 and the milling function by 46. Deairing and sieving functions are indicated by 47 and the casting process itself by 48. Compaction can be carried out at around 70° C. and is indicated by 49. Decasting and drying are designated by 50 and the sintering function by 51.

Although these inventions have been disclosed in the context of certain preferred embodiments and examples, it will be understood by those skilled in the art that the present inventions extend beyond the specifically disclosed embodiments to other alternative embodiments and/or uses of the inventions and obvious modifications and equivalents thereof. For example, it is realized that other monomers closely related to the specified HEMA-PEG400-DMA can be used in the invention. In addition, while several variations of the inventions have been shown and described in detail, other modifications, which are within the scope of these inventions, will be readily apparent to those of skill in the art based upon this disclosure. It is also contemplated that various combination or sub-combinations of the specific features and aspects of the embodiments may be made and still fall within the scope of the inventions. It should be understood that various features and aspects of the disclosed embodiments can be combined with or substituted for one another in order to form varying modes of the disclosed inventions. Thus, it is intended that the scope of at least some of the present inventions herein disclosed should not be limited by the particular disclosed embodiments described above.

1-14. (canceled)

15. A method for manufacturing a dental component comprising:
providing a first cast part, the first cast part defining a first volume and an outer shape corresponding to an inner shape of the dental component;
providing a second cast part, the second cast part defining a space having an interior volume greater than the first volume of the first cast part;
positioning the first cast part in the space of the second cast part;
applying a gel slurry intermediate the first and second cast parts;
solidifying the gel slurry to form a solidified gel slurry;
removing the first cast part together with the solidified gel slurry from the second cast part;
machining the solidified gel slurry to form an exterior shape corresponding to a desired exterior shape of the dental component; and
sintering the solidified gel slurry.

16. The process recited in claim 15, further comprising milling the first cast part to define the outer shape and the first volume.

17. The process recited in claim 16, wherein the solidified gel slurry defines an internal cavity corresponding to the first volume and the outer shape of the first cast part.

18. The process recited in claim 17, further comprising removing the first cast part from the solidified gel slurry and drying the solidified gel slurry such that the internal cavity of the dried gel slurry decreases to a second volume.

19. The process recited in claim 18, further comprising machining the outer shape of the first cast part to correspond to the second volume of the internal cavity of the dried gel slurry.

20. The process recited in claim 19, further comprising repositioning the first cast part in the internal cavity of the dried gel slurry.

21. The process recited in claim 18, further comprising repositioning the first cast part in the internal cavity of the dried gel slurry.

22. A dental component comprising a component body defining an internal cavity and an external shape, the component body being formed from a sintered gel slurry.

23. The dental component of claim 22, wherein the gel slurry comprises zirconia, monomers, water, and dispersant.

24. The dental component of claim 23, wherein the gel slurry is included in an acrylate amide-based system.

25. The dental component of claim 24, wherein the gel slurry is included in a HEMA-PEG 400 DMA system.

26. The dental component of claim 22, wherein the dental component comprises a component of a dental crown.

27. The dental component of claim 22, wherein the dental component comprises a component of a dental bridge.

28. A method for manufacturing a dental component comprising:
positioning a first cast part with an outer shape corresponding to an inner shape of a dental component into an interior space of a second cast part;
inserting a gel slurry to the interior space of the second cast part;
allowing the gel slurry to form a solidified gel slurry;
removing the first cast part and the solidified gel slurry from the second cast part;
removing a portion of the solidified gel slurry to form an exterior shape corresponding to a desired exterior shape of the dental component; and
sintering the solidified gel slurry.

29. The process recited in claim 28, further comprising machining the first cast part to define the outers shape of the first cast part.

30. The process recited in claim 28, wherein the step of removing a portion of the solidified gel slurry comprises machining the first cast part to form the desired exterior shape.

31. The process recited in claim 28, further comprising removing the first cast part from the solidified gel slurry and drying the solidified gel slurry such that the internal cavity of the dried gel slurry decreases to a second volume.

32. The process recited in claim 31, further comprising machining the outer shape of the first cast part to correspond to the second volume of the internal cavity of the dried gel slurry.

33. The process recited in claim 32, further comprising repositioning the first cast part in the internal cavity of the dried gel slurry.

34. The process recited in claim 28, wherein the step of removing the first cast part and the solidified gel slurry from the second cast part comprises removing both the first cast part and the solidified gel slurry together from the second cast part.

35. The process recited in claim 28, wherein the step of removing the first cast part and the solidified gel slurry from the second cast part comprises removing the first cast part from the solidified gel slurry before removing the solidified gel slurry from the second cast part.
